(19) United States
(12) Patent Application Publication
(10) Pub. No.: US 2020/0181019 A1
(43) Pub. Date: Jun. 11, 2020

(54) MODIFIED ASPHALT WITH HIGH ADHESION AND WATER RESISTANCE

(71) Applicant: GRUPO ASFALTO PROCESADOS, S.A. DE C.V., Culiacán, Sinaloa (MX)

(72) Inventor: RICARDO AZPE MEZA, CULIACAN (MX)

(21) Appl. No.: 16/341,007

(22) PCT Filed: Nov. 29, 2016
(86) PCT No.: PCT/MX2016/000121

§ 371 Date: Apr. 10, 2019

(51) Int. Cl. C04B 26/26; C04B 24/42; E01C 7/26

(52) U.S. Cl. CPC C04B 26/26; C04B 2111/27; E01C 7/26; C04B 24/42

(57) ABSTRACT

Asphalt, chemically reacted, comprising a bifunctional organosilane of the epoxy, amino and ureide type in a proportion of 0.4 to 2% by weight; at least one petrous aggregate; and a catalyst in a proportion of 10 to 20% by weight; wherein said bifunctional organosilane is selected from the groups consisting of 2-(3,4-epoxycyclohexyl)-ethyltrimetoxisilane, 2-3,4-epoxycyclohexyl)-ethyltrietoxisilane, 3-aminopropyltriethoxysilane, 3-aminopropyl silanetriol, 3-aminopropyltrimethoxysilane, 3-aminopropylmethyldiethoxysilane, N-(2-aminoethyl)-3-aminopropylmethyldimetilsilane, 3-(2-aminoethylaminopropyl)-trimethoxysilane, N-(2-aminoethyl)-3 aminopropyl triethoxysilane, 3-(2-aminoethylamino)-propyl-dimethoxysilane, trimethoxysilane diethylenetriamine propyl-3, γ-piperazinyl butyl dimethyl propyl silane, 3-(N-phenylamine) propyltrimethoxysilane, 3-(N, N-dimethylaminopropyl) aminopropyl-methyldimethoxysilane, 3-ureidepropyltrimethoxysilane, 3-ureidepropyltrietoxisilano; and wherein said bifunctional organosilane increases the asphalt adhesion with the at least one petrous aggregate and the water resistance even in case of immersed into the same. Said asphalt is designed to be used in the production of hot and cold asphaltic mixtures as well as foamed asphalt, asphaltic emulsions and other applications related to the use thereof.

### TECHNICAL FIELD

The present invention is directed to the technical field of the science of building materials. Particularly, the present invention refers to an asphalt chemically reacted with compounds of the organosilane type for improving adhesion of the asphalt with the aggregates and a greater water resistance.

### BACKGROUND OF THE INVENTION

As is well known in the prior art, asphalt is a cementitious material containing predominantly bitumens which are a mixture of highly viscous organic substances of black color and high density, which are produced in nature or are obtained as residue during the refining of petroleum. Chemically, asphalt consists of condensed aromatic hydrocarbons, however, contains several reactive groups, in particular groups including double bonds carbon-carbon. In terms of distribution, asphalt is a plastisol conformed by graphite particles suspended in a viscous liquid. These particles are of the same chemical type but differ from each other in molecular weight. The liquid phase of asphalt is formed predominantly by condensed aromatic hydrocarbons of low molecular weight, while the part of the graphite is composed of condensed aromatic hydrocarbons of high molecular weight.

Despite having these two main phases, asphalt is a highly complex material, which is not well characterized with respect to the variety of aromatic and saturated and unsaturated aliphatic compounds. These compounds may include up to 150 carbon atoms. Said compositions may vary depending on the source from which the asphalt comes. A typical composition of the asphalt containing about 80% of carbon; 10% of hydrogen; 6% of sulfur; traces of oxygen and nitrogen as well as metals such as iron, nickel and vanadium.

Now then, the main application of asphalt is in road paving, not being its only use, thus, the asphalt must possess good physical properties such as strength as well as being physically and chemically inert. However, one of the difficulties of the asphalt is that when it is combined with petrous aggregates shows incompatibilities, mainly those caused by the hydrophilic nature of the aggregates. Whereby emerging the need to modify the asphalt with additives that reduce their hydrophobicity, and improve their compatibility with the petrous.

In this sense, it has the document U.S. Pat. No. 2,570,185, wherein compatibility between asphalt and aggregates can be increased by the combination with amino alkoxysilanes and aliphatic primary amines of high molecular weight. Likewise, the documents U.S. Pat. Nos. 4,036,661 and 4,038,096, which describe the use of organofunctional silanes as adhesion promoters for the compositions asphalt-aggregate. In said documents the importance of the thermal stability of these compounds is remarked, so that in addition to promote the adhesion of asphalt with the aggregate, this maintains its stability in a wide range of temperatures for a prolonged period of time. That is why to modify asphalt the compounds must meet certain characteristics such as: being stable to oxidation during processing and long-term aging, stability at temperatures above 180° C. and a high boiling point.

Similarly, in the prior art there are different types of asphalts, which generally refer to modified asphalts with organosilicons instead of organosilanes, which are used as additives, such as that disclosed by U.S. Pat. No. 8,771,413 B2, which refers to different asphalt compositions and asphalt-mineral including at least one organic compound of cationic silicon selected from different groups. Compared with the modified asphalt with organosilanes, the advantage presented by them compared to cationic silicon compounds is that their economic cost is lower and are used in much smaller percentages (0.2-2%) compared to 0.5-3% used with the other compounds.

On the other hand, the document MX/a/2010/010566, which discloses a method of producing asphalt, fuels and lubricant bases, which consists of the physical processes of flash distillation, fractional distillation under high vacuum or with steam stripping, clay treatment and injection of asphaltene dispersant to work both in asphalt mode as in lubricants mode, however, none of the products obtained by the processes disclosed in this document refers to an asphalt chemically reacted with compounds of the organosilane type for improving asphalt adhesion with the petrous aggregates and greater water resistance.

Therefore, the present invention refers to a chemically modified asphalt by means of organosilanes compounds, preferably that called “GLYMO”. Said organosilanes contain two functional groups, one that chemically reacts with the asphalt, joining covalently to this. Whereby forming an asphalt with terminals of the silane type. Said groups at a suitable temperature (>100° C.) are capable of reacting with the silicon atoms of the petrous aggregates, generating a strong chemical bond of the covalent type, not allowing that the water displaces the asphalt from the surface of the petrous aggregate. Said reacted asphalt, presents the typical features of a normal asphalt so it can be used for the production of asphaltic mixes, hot and cold, as well as foamed asphalt, asphalt emulsions, and other applications related to the use thereof.

### OBJECTS OF THE INVENTION

It is, therefore, an object of the present invention to provide an asphalt chemically reacted with organosilanes compounds which provides a strong chemical bond of covalent type, which generates interactions stable enough to hold the petrous and asphalt bonded even in wet conditions.

A further object of the present invention to provide an asphalt chemically reacted with organosilanes compounds with high water resistance, which does not allow that said water displaces the asphalt from the surface of the petrous aggregate.

Another object of the invention to provide an asphalt chemically reacted with organosilanes compounds which improves the adhesion of asphalt with the aggregates.

A further object of the present invention to provide an asphalt chemically reacted with organosilanes compounds with organosilanes compounds, which allows the asphalt modification from the use of recycled materials, the product of the distillation of petroleum.

Still a further object of the present invention to provide an asphalt chemically reacted with organosilanes compounds which present an improved adhesion to a wide variety of aggregate particles.

An object of the present invention is to provide a reacted asphalt which presents the same features of a normal asphalt related to that this can be used for the production of hot and cold asphalt mixtures as well as foamed asphalt, asphaltic and other applications related to use thereof.

### BRIEF DESCRIPTION OF THE INVENTION

The present invention refers to a chemically reacted asphalt, comprising a bifunctional organosilane of the epoxy, amino and ureide type in a proportion of 0.2 to 2% by weight, and in further embodiments in a proportion from 0.85 to 2% by weigh; at least one petrous aggregate; and a catalyst in a proportion of 10 to 20% by weight, wherein said bifunctional organosilane is preferably 3-glycidoxypropyltrimethoxysilane (GLYMO), and wherein said bifunctional organosilane increases the asphalt adhesion with the petrous aggregates and the water resistance even in case of immersed into the same.

Additional features and advantages of the invention should be more clearly understood from the detailed description of the preferred embodiment thereof, given by way of illustrative examples but non limitative.

### DETAILED DESCRIPTION OF THE INVENTION

In accordance with the preferred embodiment of the present invention, the reacted asphalt, chemically modified is prepared from the reaction of said asphalt with a bifunctional organosilane such as 3-glycidoxypropyltrimethoxysilane (GLYMO). However, in further embodiments, it can be used with other types of organosilanes such as epoxy, amino and ureide. The modified asphalt of the present invention, in its composition is used especially for the improvement in the adhesion of the asphalt with the aggregates. When GLYMO is used, which is a bifunctional organosilane compound possessing an epoxide reactive organic group and hydrolyzable metoxisilyl and triethoxysilyl inorganic groups, types of covalent bonds between asphalt and the epoxide groups in GLYMO and with the epoxide groups in GLYMO and the silicate groups in petrous materials are formed, generating interactions stable enough to maintain the petrous and asphalt bonded even in wet conditions.

For this reason, in the present invention is proposed the use a modified asphalt with said bifunctional organosilanes of the epoxy, amino, and ureide type including the GLYMO. Compounds with this kind of bifunctional organosilane, chemically react with the asphalt, and once this asphalt is mixed with petrous aggregates, it also reacts giving a chemical bond between the silicon of the aggregate and that of the modified asphalt with the orgasilane, obtaining a covalent bond which is very difficult to break, whereby improving the adhesion and providing greater durability and resistance to asphalt.

Likewise, the use of compounds of the epoxy, amino and ureide silanes type, as asphalt modifiers, promotes the adhesion with aggregates even in conditions of high humidity, providing the system with water resistance. This kind of compounds has reactive groups which open in the presence of suitable catalyst, donor type, and are added mainly with sulfur and nitrogen atoms. This is how these silanes react with the petrous aggregates forming a covalent bond between the hydroxyl groups of aggregates and the silane group of the modified asphalt. This type of bond is very stable, thus it results in greater adhesion of the asphalt with the aggregates. Wherein said silanes are easily available in the market, with a suitable price for their use.

According to the previous, although in the preferred embodiment of the present invention a bifunctional organosilane which is preferably 3-glycidoxypropyltrimethoxysilane (GLYMO) is used, in additional embodiments of the invention, the bifunctional organosilane may be selected from compounds of the epoxy, amino and ureide silanes type, which are bifunctional organosilanes compounds possessing reactive organic groups and hydrolyzable inorganic silyl groups, specifically from the group consisting of: 2-(3,4-epoxycyclohexyl)-ethyltrimetoxisilane, 2-3,4-epoxycyclohexyl)-ethyltrietoxisilane, 3-aminopropyltriethoxysilane, 3-aminopropyl silanetriol, 3-aminopropyltrimethoxysilane, 3-aminopropylmethyldiethoxysilane, N-(2-aminoethyl)-3-aminopropylmethyldimetilsilane, 3-(2-aminoethylaminopropyl)-trimethoxysilane, N-(2-aminoethyl)-3 aminopropyl triethoxysilane, 3-(2-aminoethylamino)-propyl-dimethoxysilane, trimethoxysilane diethylenetriamine propyl-3, γ-piperazinyl butyl dimethyl propyl silane, 3-(N-phenylamine) propyltrimethoxysilane, 3-(N, N-dimethylaminopropyl) aminopropyl-methyldimethoxysilane, 3-ureidepropyltrimethoxysilane, 3-ureidepropyltrietoxisilano. Whose chemical formula is:
C₉H₂₀O₅Si
C₁₁H₂₂O₄Si
C₁₄H₂₈O₄Si
C₉H₂₃NO₃Si
C₃H₁₁NO₃Si
C₆H₁₇NO₃Si
CH₃Si(OC₂H₅)₂(CH₂)₃NH₂
C₈H₂₂N₂O₂Si
C₈H₂₂N₂O₃Si
C₁₁H₂₈N₂O₃Si
C₈H₂₂N₂O₂Si
C₁₀H₂₇N₃O₃Si
C₁₀H₂₄N₂O₂Si
C₈H₂₁NO₃Si
C₇H₁₈N₂O₄Si
C₁₀H₂₄N₂O₄Si

Likewise, the petrous aggregates used for the manufacturing of the modified asphalt of the present invention refer to petrous aggregates which are materials in the form of coarse particles used in construction, which are preferably selected from the group consisting of: sand, gravel, crushed stone, soil, rubble, recycled concrete, or mixtures thereof. Or the group consisting of: dolomite, granite, crushed gravel, sandstone, limestone, basalt and other inorganic stones.

Said aggregates are used to form asphaltic mixtures, which react with the modified asphalt, since this modified asphalt has silanes functional groups (eg. Silanol groups) on the surface. These silanols are created by hydrolysis of silane groups and react with the silicon atoms of the petrous aggregates.

In this aspect, the present invention provides asphalt compositions with which a variety of aggregates can be used. The modified asphalt according to the methodology of the present invention exhibits an improved adhesion to a wide variety of aggregate particles. That is, the asphalt modified with GLYMO, has an adhesion significantly greater with petrous aggregates after the repeated exposure or immersion in water.

This makes the asphalt and the aggregates into versatile products with applications in a large number of industries.

In this sense, the modification of asphalt with the silanes in a suitable amount is capable of increasing substantially the amount of asphalt retained by the aggregates after a water immersion test. This necessary amount of silane to substantially increase the retention of asphalt by the aggregates was found in 0.85% by weight with respect to the asphalt using up to 20% of polyphosphoric acid as catalyst with respect to silane. The reaction is carried out at >100° C., for a time of at least 2 hours, with vigorous and constant stirring. Wherein it cab be also used in the production of the hot and cold asphaltic mixtures as well as foamed asphalt, asphalt emulsions and other applications related to the use thereof.

Next, some examples carried out for the present invention are shown, which include modifications of asphalt with GLYMO (3-glycidoxypropyltrimethoxysilane) with 0.85% to 2% by weight with respect to asphalt:

### EXAMPLES

Adhesion Test Asphalt-Aggregate

Loss of Stability by Immersion in Water of Asphaltic Mixtures (M-MMP-4-05-041/03)

6 servings of petrous aggregates according to the Norm N-CMT-4-04/08 were prepared adding reacted asphalt according to the proportions established in the Norm (M-MMP-4-05-041/03) and compacting following the methods described in the same Norm. Likewise, the deformation resistance was calculated applying a deformation rate of 1 cm/min until reach its rupture, said value was recorded and subsequently a homologous sample was immersed in water for 4 days (M-MMP-4-05-041/03), extending up to 7 days for the reacted asphalt. After said 4 days and 7 days the deformation resistance of the immersed samples was calculated. The resistance of the reacted asphalt was calculated by the relation between the difference of the resistance of the original sample and the resistance of the immersed sample, recording this value in percentage. Values below 80% indicate a poor resistance of the asphalt after the test, and thus said test is considered as invalid.

### Example 1

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The reacted asphalt was mixed with the petrous aggregates according to the Norm N-CMT-4-04/08. The Mixing lasted 15 minutes at 135° C. and then it was allowed to cool at room temperature. Tests of immersion in water were carried out during 4 and 7 days. The results are shown in Table 1.

TABLE 1
Loss of stability by immersion in water of asphaltic mixtures

| | REACTED | NORMAL |
|---|---|---|
| Test M-MMP-4-05-041/03 | ASPHALT | ASPHALT |
| 4 DAYS | 98% | 80% |
| 7 DAYS | 98% | 75% |

The results show a significant improvement of the reacted asphalt over the normal asphalt.

Water Effect on Asphaltic Mixtures with Aggregates Using Boiling Water (ASTM D 3625-96)

It was prepared mixtures in proportions of reacted asphalt and petrous according to Norm ASTM D 979. Prior the mixture, the elements are heated at 165° C. The mixture is cured during 15 minutes at 135° C. After ths, the samples are cooled and subjected to the water immersion test, evaluating them in heated water at temperatures above of 85° C. and below to the water boiling point during 10 minutes, extending to 2 hours. The loss of adhesion of the aggregates with the asphalt is evaluated visually, reporting the observed detachment as null, little, much or excessive detachment as the case.

### Example 2

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The reacted asphalt was mixed with the petrous aggregates according to Norm ASTM D 979. The mixing lasted 15 minutes at 135° C. and then it was allowed to cool at room temperature. Tests of immersion in boiling water according to Norm ASTM D 3625-96 and the test was extended for 2 hours (120 minutes) of immersion. The results are shown in Table 2.

TABLE 2
Water effect on asphaltic mixtures with aggregates using boiling water.

| | REACTED | NORMAL |
|---|---|---|
| Test ASTM D 3625-96 | ASPHALT | ASPHALT |
| 10 minutes | NULL DETACHMENT | EXCESSIVE DETACHMENT |
| 120 minutes | NULL DETACHMENT | EXCESSIVE DETACHMENT |

The results show a significant improvement of the reacted asphalt over the normal asphalt.

Resistance Test of the Compacted Asphaltic Mixture to the Moisture Damage Induction (AASHTO T 283 TSR)

6 servings of petrous aggregates according to the Norm N-CMT-4-04/08 were prepared adding reacted asphalt according to the proportions established in the Norm AASHTO T 283 TSR and compacting following the methods described in the same Norm for obtaining from 6 to 8% of air spaces. 3 samples are selected as a control and are tested without moisture conditioning. The other 3 samples are conditioned by saturation with water followed by a freeze cycle and then they are placed in a soaking cycle in warm water. The treated samples are tested to measure the tension force indirectly through loading the samples to a stress of constant deformation measuring the force required to break the sample. The asphalt resistance to rupture is calculated by the relationship between the difference of the resistance of the original sample and the resistance of the immersed sample, recording this value as a percentage. Values below 80% indicate a poor resistance of the asphalt after the test, and thus said test is considered as invalid.

### Example 3

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The reacted asphalt was mixed with the petrous aggregates according to the Norm AASHTO T 283 TSR the Mixing lasted 15 minutes at 135° C. and then it was allowed to cool at room temperature. Tests of immersion were carried out and the relationship between the deformation resistance of the immersed samples and the non-immersed was calculated, the result being reported in percentage (%). The results are shown in Table 3.

TABLE 3
Resistance Test of the compacted asphaltic
mixture to the moisture damage induction

| | REACTED | NORMAL |
|---|---|---|
| Test AASHTO T283 TSR | ASPHALT | ASPHALT |
| Deformation Resistenace (%) | 95% | 83% |

The results show a significant improvement of the reacted asphalt over the normal asphalt.

Friction Detaching Test in Petrous Materials for Asphaltic Mixtures (M-MMP-4-04-009/03)

6 servings of petrous aggregates according to the Norm N-CMT-4-04/08 were prepared adding reacted asphalt according to the proportions established in the Norm (M-MMP-4-05-041/03) and compacting following the methods described in the same Norm. Once the sample is homogeneous fractions of 50 g each are taken for testing and allowed to cool. They are placed in glass bottles of 500 cm³ and covered with distilled water at 25° C. They are capped and left rest for 24 h. Having no detaching of the asphalt film, the samples are placed in stirring from 45 to 50 rpm for 4 periods of 15 minutes each. The samples were visually inspected to evaluate the detachment of the asphalt film and the percentage of friction detachment of the asphalt film is calculated by calculating the average of friction loss of all the samples. The asphalt is classified according to the detachment percentage: 0%-10% asphalt with normal adherence, 10%-25% asphalt with regular adherence, detachment during 24 h or greater than 25% asphalt with low adherence.

### Example 4

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The reacted asphalt was mixed with the petrous aggregates according to Norms M-MMP-4-04-001 y N-CMT-4-04. The Mixing lasted 15 minutes at 135° C. and then it was allowed to cool at room temperature. Tests of immersion in water were carried out during 24 hours and due to the fact that there was not detachment of the asphalt film, the samples were stirred from 45 to 50 rpm for 4 periods of 15 minutes each. The samples were visually inspected to evaluate the detachment of asphalt film and the percentage of friction detachment of the asphalt film was calculated through calculate the average of the friction loss of all the samples. The asphalt was classified according to the detachment percentage in: 0%-10% asphalt with normal adherence, 10%-25% asphalt with regular adherence, detachment during 24 h or greater than 25% asphalt with low adherence. The results are shown in Table 4

TABLE 4
Friction detaching test in petrous materials for asphaltic mixtures.

| | REACTED | NORMAL |
|---|---|---|
| M-MMP-4-04-009/03 | ASPHALT | ASPHALT |
| FRICTION DETACHMENT | NULL DETACHMENT | EXCESSIVE DETACHMENT |

The results show a significant improvement of the reacted asphalt over the normal asphalt.

Test for Determining the Flashpoint Using a Cleveland Open Cup (ASTM 92)

This method is used with the objective of determining the flash and combustion points, in an open cup. 3 asphalt samples were prepared which are heated until obtain a reasonable fluency of the material and at 17° C. below the expected flashpoint. Once the asphalt is provided as a fluid, the cup is filled with the sample to be tested until a level marked on its inner wall. The cup is located on a heating plate and with a thermometer (from 0° C. to 350° C.) in vertical position which is introduced into the sample until 6 or 7 mm above the bottom of the cup. The test flame is lighted and adjusted to a size of 4 mm of diameter. The sample is warmed at temperature increases from 14° C./min to 17° C./min until reach 56° C. below the probably flashpoint. After this point the heating rate is decreased when missing 28° C. for probably flashpoint until obtain temperature increases from 5° C./min to 6° C./min. From this moment the test flame is applied every 20 seconds or every 2° C. of elevation. The lowest temperature is considered as the flashpoint when a momentary flare is clearly manifested on the sample surface.

### Example 5

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The asphalt sample was prepared according to the stated in the Norm ASTM 92 for determining the flashpoint. This flashpoint was taken as the lowest temperature of flashpoint when a momentary flare was clearly manifested on the sample surface during more than 5 seconds. The results are shown in Table 5

TABLE 5
Test for determining the flashpoint using a Cleveland open cup.

| | | REACTED | NORMAL |
|---|---|---|---|
| ASTM 92 | ESPECIFICATION | ASPHALT | ASPHALT |
| FLSHPOINT (° C.) | 230 minimum | >300 | >300 |

The results show a significant improvement of the reacted asphalt over the normal asphalt.

Test for Determining the Viscosity of the Asphalt at High Temperatures Using a Rotational Viscometer (ASTM 4402)

This method determines the consistency of the asphalt at high temperatures (135° C.), by measuring its deformation resistance. 3 asphalt samples of 8 mL were prepared, according to the team's recommendations. These samples are heated until obtain a reasonable fluency of the material. The thermal container is filled with the sample stirring until obtain a homogeneous sample. The test chamber is located on the thermal container and the rotor is adjusted to the indicated depth (3.2 mm above the top of the interface between the conical body of the rotor and its arm) and is left rest until obtain a constant test temperature (135° C.). Once the right temperature is obtained the test is started at 12 rpm recording readings at intervals of 60 s and reporting the viscosity in Pa·s.

### Example 6

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The asphalt samples were prepared according to the stated in the Norm ASTM 4402. These samples are heated until obtain a reasonable fluency of the material. The thermal container was filled with the sample stirring until obtain a homogeneous sample. Subsequently, the test chamber was located on the thermal container and the rotor was adjusted to the indicated depth and was left rest until obtain a constant test temperature. Once the right temperature was obtained the test was started at 12 rpm recording readings at intervals of 60 s and reporting the viscosity in Pa·s.

TABLE 6
Test for determining the viscosity of the asphalt
at high temperatures using a rotational viscometer

| | | REACTED | NORMAL |
|---|---|---|---|
| ASTM 4402 | ESPECIFICATION | ASPHALT | ASPHALT |
| VISCOSITY | 3000 maximum | 367 | 363 |
| BROOKFIEL AT | | | |
| 135° C., SC4-27, 12 | | | |
| RMP (cP) | | | |

Test for Determining the Heat and Air Effect in a Moving Asphalt Film (ASTM D 2872)

A key aspect in the evaluation of asphalt binders with Superpave system is that the physical properties are measured on binders that have been aged in the laboratory to simulate the aging conditions on a pavement in operation. The physical properties are measured by rheology of the aged binders in RTFO (Rolling Thin Film Oven), to simulate hardening by oxidation that occurs during hot mixing and placement.

### Example 7

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The asphalt samples were prepared according to the stated in the Norm ASTM D 2872.

TABLE 7
Test for determining the heat and
air effect in a moving asphalt film

| | | REACTED | NORMAL |
|---|---|---|---|
| ASTM D 2872 | ESPECIFICATION | ASPHALT | ASPHALT |
| MASS LOSS BY | 1 MAXIMUM | 0.42 | 0.48 |
| HEATING (%) | | | |

Test for Determining the Rheological Properties of the Asphaltic Binder Using a Standard Dynamic Shear Rheometer (ASTM D 7175)

Once performed the requested aging, the samples are measured in the DSR (Dynamic Shear Rheometer), to characterize the visco-elastic properties of the binder. The complex module in cutting was measured (G*), the phase angle (δ) subjecting a small sample of binder to oscillating cutting tensions, the sample is placed between two parallel plates. The DSR G* and δ is calculated by measuring the response of the shear specific deformation of the specimen submitted to a torque. The conditions for oerforming this test are documented in the Norm ASTM D7175. The test limits are for the original condition of temperature where the G*/sin (δ) is a minimum of 1.00 kPa.

### Example 8

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The samples were prepared according to the stated in the Norm ASTM D7175. The test limits are for the original condition of temperature where the G*/sin (δ) is a minimum of 1.00 kPa. The G* and δ were calculated measuring the response to the specific shear deformation of the sample subjected to a torque, for the samples of normal asphalt and reacted asphalt.

TABLE 8
Test for determining the rheological properties of the asphaltic
binder using a Standard dynamic shear rheometer.

| | | REACTED | NORMAL |
|---|---|---|---|
| ASTM D 7175 | ESPECIFICATION | ASPHALT | ASPHALT |
| RHEOLOGICAL | 1 MINIMUM | 1.049 | 1.052 |
| MODULE OF | | | |
| DYNAMIC | | | |
| SHEAR(KPa) | | | |
| PHASE ANGLE (°) | | 85.92 | 85.91 |

Standard Test for Accelerated Aging of Asphalt Binder Using a Pressure Aging Vessel (ASTM 6521)

Another aging step that can be measured posteriorly to RTFO is the PAV aging (Pressure Aging Vessel) where it also simulated the hardening by oxidation that occurs during the hot mixing and placement, the severe aging suffering the binder after several years of service on a pavement.

### Example 9

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The film formed by this test is used for the ASTM D 6648 test.

TABLE 9
Standard test for accelerated aging of asphalt
binder using a pressure aging vessel.

| | REACTED | NORMAL |
|---|---|---|
| ASTM D 6521 | ASPHALT | ASPHALT |
| WASTE OF THE | Satisfactory | Satisfactory |
| PRESSURE AGING | | |
| TEST | | |

Standard Test for Determining Bending, Creep and Rigidity of the Asphalt Binder Using a Bending Beam Rheometer (ASTM D 6648)

This test method is used for determining the rigidity to the bending-creep, or elasticity and an m value of asphalt binders by a bending beam rheometer. For samples with values of rigidity to the bending in the range of 20 MPa to 1 GPa and at temperatures between −36° C. to 0° C.

### Example 10

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. Prior the test, the samples were prepared according to the stated in the Norm ASTM D 6648. This test was carried out under conditions of temperature of −12° C. The results are shown in Table 10.

TABLE 10
Standard Test for determining bending, creep and rigidity
of the asphalt binder using a bending beam rheometer

| | | REACTED | NORMAL |
|---|---|---|---|
| ASTM 6648 | ESPECIFICATION | ASPHALT | ASPHALT |
| RIGIDITY IN | 300 maximum | 146.62 | 146.95 |
| CREEP (MPa) | | | |
| VALUE m(t), | 0.3 minimum | 306 | 306 |
| dimensionless | | | |

Standard Test for Determining the Creep Recovery of Multiple Stress of the Asphaltic Binder Using a Standard Dynamic Shear Rheometer (AASHTO T-350)

This standard test is used to determine the rheological properties of the asphalt using a Dynamic Shear Rheometer with a geometry of parallel plate of 25 mm and 1 mm of aperture. Two shear stresses of 100 Pa and 3200 Pa are employed. The samples are prepared according to the stated in the Norm AASHTO T-350. The phase of stress of the test lasts 1 second followed by a recovery period of 9 seconds.

### Example 11

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. The samples were prepared according the stated on the Norm AASHTO T-350. The phase of stress of the test lasts 1 second followed by a recovery period of 9 seconds. 10 cycles of stress and recovery were made. The creep compliance and the percentage of elastic response for each of the shear stress and the difference in creep compliance for both efforts were calculated. The results are shown in Table 11.

TABLE 11
Standard Test for determining the Creep recovery of multiple stress
of the asphaltic binder using a Standard dynamic shear rheometer.

| | REACTED | NORMAL |
|---|---|---|
| AASHTO T-350 | ASPHALT | ASPHALT |
| ELASTIC RESPONSE, 100 | 9.62 | 9.31 |
| Pa (%) | | |
| ELASTIC RESPONSE, | 2.34 | 2.18 |
| 3200 Pa (%) | | |
| DIFFERENCE IN ELASTIC | 75.63 | 74.96 |
| RESPONSE (%) | | |
| CREEP COMPLIANCE | 2.24 | 2.12 |
| JNR100 (%) | | |
| CREEP COMPLIANCE | 2.682 | 2.63 |
| JNR3200 (%) | | |
| DIFFERENCE IN CREEP | 19.74 | 19.89 |
| COMPLIANCE JNR (%) | | |

Hamburg Loaded Wheel Test for Compacted Asphaltic Mixtures (AASHTO T 324)

The Hamburg has as objective measuring the resistance to rutting and the threshing of a compacted asphaltic mixture in the laboratory or 10-inch hearts drawn directly from the pavement. The test consists of two steel wheels of 47 mm which move axially on a sample made in the laboratory of 36×26 cm or a heart extracted from field of 250 mm (10″). The load of the wheel is of 0.71 kN (158 lb) with a contact pressure of 217 psi. The specimens are tested at 50° C. and completely immersed in a water bath. The speed of the wheel is 30 cm per second, the test runs 20 000 cycles or to a limit deformation of 20 mm. The failure criterion in the defined specification is 10 mm of maximum deformation on highways.

### Example 12

Reacted asphalt Grade PG 76-22 at 25° C. The samples were prepared to contain 0.0% (normal asphalt) and 0.85% (reacted asphalt) by weight of 3-glycidoxypropyltrimethoxysilane with respect to asphalt and 20% by weight of the catalyst (polyphosphoric acid) with respect to 3-glycidoxypropyltrimethoxysilane, carrying out the reaction during 4 hours until 220° C., under constant stirring. 2 samples of petrous aggregates and reacted asphalt were prepared according to the design to obtain a dense mixture of high performance, which is based on the volumetric properties of the mixture. The design was carried out with the reacted asphalt and the granulometry was the following: 50% gravel, 10% seal and 40% sand; with an asphalt content of 6.8% relative to the weight of the aggregate. The size of both samples for their evaluation was 36×26 cm, at a temperature of 50° C. Said samples were placed in a water bath at the same temperature (50° C.) and were induced a wheel load of 0.71 kN, with a contact pressure of 217 psi and a speed of 30 cm/s to complete 20 000 cycles. The results are shown in Table 12.

| | | REACTED | NORMAL |
|---|---|---|---|
| AASHTO T 324 | ESPECIFICATION | ASPHALT | ASPHALT |
| DEFORMATION | 10 mm MAXIMUM | 3.63 | 5.38 |
| (mm) | | | |

The results show a significant improvement of the reacted asphalt over the normal asphalt.

Since several aspects of various embodiments of this invention have been described, it should be noted that those skilled in the art can make various alterations, modifications and improvements. Such alterations, modifications and improvements are intended to be part of this disclosure and are intended to be within the spirit and scope of the invention. Thus, the foregoing description and drawings are only by way of example.

1. An asphalt, chemically reacted, comprising a bifunctional organosilane of the epoxy, amino and ureide type in a proportion of 0.2 to 2% by weight; and a catalyst in a proportion of 10 to 20% by weight; wherein said bifunctional organosilane is preferably 3-glycidoxypropyltrimethoxysilane (GLYMO), and wherein said bifunctional organosilane increases the asphalt adhesion with the petrous aggregates and the water resistance even in case of immersed into the same.

2. The reacted asphalt according to claim 1, further comprising polyphosphoric acid as catalyst.

3. An asphalt, chemically reacted, comprising a bifunctional organosilane of the epoxy, amino and ureide type in a proportion of 0.4 to 2% by weight; at least one petrous aggregate; and a catalyst in a proportion of 10 to 20% by weight; wherein said bifunctional organosilane increases the asphalt adhesion with the at least one petrous aggregate and the water resistance even in case of immersed into the same.

4. The reacted asphalt according to claim 1, wherein the at least one aggregate is selected from the group consisting of: sand, gravel, crushed stone, soil, rubble, recycled concrete, or mixtures thereof.

5. The reacted asphalt according to claim 1 or 3, wherein the bifunctional organosilane is selected from the group consisting of: 2-(3,4-epoxycyclohexyl)-ethyltrimetoxisilane, 2-3,4-epoxycyclohexyl)-ethyltrietoxisilane, 3-aminopropyltriethoxysilane, 3-aminopropyl silanetriol, 3-aminopropyltrimethoxysilane, 3-aminopropylmethyldiethoxysilane, N-(2-aminoethyl)-3-aminopropylmethyldimetilsilane, 3-(2-aminoethylaminopropyl)-trimethoxysilane, N-(2-aminoethyl)-3 aminopropyl triethoxysilane, 3-(2-aminoethylamino)-propyl-dimethoxysilane, trimethoxysilane diethylenetriamine propyl-3, γ-piperazinyl butyl dimethyl propyl silane, 3-(N-phenylamine) propyltrimethoxysilane, 3-(N, N-dimethylaminopropyl) aminopropyl-methyldimethoxysilane, 3-ureidepropyltrimethoxysilane, 3-ureidepropyltrietoxisilano.

6. The reacted asphalt according to claim 3, wherein the used petrous aggregates are selected from the group consisting of: dolomite, granite, crushed gravel, sandstone, limestone, basalt and other inorganic stones.

7. The reacted asphalt according to claim 3, further comprising polyphosphoric acid as catalyst.
